(19) United States
(12) Patent Application Publication
(10) Pub. No.: US 2009/0326970 A1
(43) Pub. Date: Dec. 31, 2009

(54) AWARDING USERS FOR DISCOVERIES OF CONTENT BASED ON FUTURE POPULARITY IN A SOCIAL NETWORK

(75) Inventors: Julio Estrada, Medina, WA (US); Chinmay Lonkar, Kirkland, WA (US); Christopher B. Weare, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/164,531

(22) Filed: Jun. 30, 2008

(51) Int. Cl. G06Q 99/00

(52) U.S. Cl. 705/1

(57) ABSTRACT

A reputation system used in a social networking service provides for recognition for its members in the form of badges that can be displayed on the members' profile pages as a way of indicating a particular status. In various illustrative examples, a “tastemaker” badge may be awarded to a member who plays or recommends to other members (through various recommendation channels such as messages, shared playlists, etc.) particular pieces of media content such as songs or videos in advance of that content becoming popular with the larger community of members in the social network. The tastemaker badge can then be placed on the member's profile page as a symbol of recognition or achievement that can help to increase that member's reputation in the social network.

### BACKGROUND

Web-based social networking has become a popular way for people to meet and interact with people over public networks like the Internet. Typically, social networking is implemented by websites that provide a social networking service. Social networking services are often stand alone or dedicated web-based services although some services are integrated as part of other service offerings. For example, Microsoft Corporation provides the “Zune Social” brand of social networking service in combination with a media content delivery service for its popular Zune® brand of personal media player.

To use a web-based social networking service, a member may provide information to set up an account with a social networking service. Once a member's account is configured, users can generate “profiles” of themselves. The profiles typically contain a variety of information about a user (such as location, occupation, hobbies, likes/dislikes, friends/social graph, etc.).

Social networking services allow members to view other member profiles, join groups with a common subject or theme, add other members to a contact list, and send messages to other members. Some social networking services are reputation-based where members can receive reviews and ratings from other users and/or receive recognition for possessing certain attributes or performing certain actions. For example a social network member might be a “Power Reviewer” by posting a certain number of reviews or comments about particular topics or subjects. Such reputation features can often add additional dimensions of entertainment and interest in the services because they give members more ways to socially interact. Other members like the recognition features which can help to differentiate them from other members or function as trophies or other indicators of status or standing in the social network.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A reputation system used in a social networking service provides for recognition for its members in the form of badges that can be displayed on the members' profile pages as a way of indicating a particular status. In various illustrative examples, a “tastemaker” badge may be awarded to a member who plays or recommends to other members (through various recommendation channels such as messages, shared playlists, etc.) particular pieces of media content such as songs or videos in advance of that content becoming popular with the larger community of members in the social network. The tastemaker badge can then be placed on the member's profile page as a symbol of recognition or achievement that can help to increase that member's reputation in the social network.

The reputation of the member as a tastemaker (i.e., a person who is able to spot or lead trends or otherwise be influential in shaping opinions) may be determined by calculating a “popularity difference” for the particular piece of played or recommended media content over some time period. The system tracks usage of all media content throughout the social network so that the difference between a play count of the particular media content at the time of calculation and the play count at the time the content was first played or recommended by the member can be calculated. Higher magnitudes of popularity differences and/or steeper growth rates in popularity difference can indicate greater ability of the member to identify content that will become popular in the larger social network. Differing levels of tastemaking ability may be reflected in different badges, styles, or attributes. For example, a member with a “5 Star” tastemaker badge indicates greater success at spotting or creating popularity trends compared with a member who has a “3 Star” tastemaker badge.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative usage environment in which a user may listen to audio content and watch video content rendered by an illustrative personal media player;

FIG. 2 shows a front view of an illustrative personal media player that supports a graphical user interface (“GUI”) on a display screen, as well as user controls;

FIG. 3 shows the portable media player when docked in a docking station that is operatively coupled to a PC and where the PC is connected to a media content delivery service and a social networking service over a network such as the Internet;

FIG. 4 shows an illustrative member card which is utilized as part of any member's profile page that is supported by a social networking service;

FIG. 5 shows an illustrative table that shows how various award levels for a tastemaker badge may be achieved by a member based on the magnitude and growth rate of popularity difference; and

FIG. 6 shows a flowchart of an illustrative method that may be used to implement the present reputation award system using a reputation system

FIG. 7 is a simplified block diagram that shows various functional components of an illustrative example of a personal media player; and

FIG. 8 is a simplified block diagram that shows various physical components of an illustrative example of a personal media player.

Like reference numerals indicate like elements in the drawings.

### DETAILED DESCRIPTION

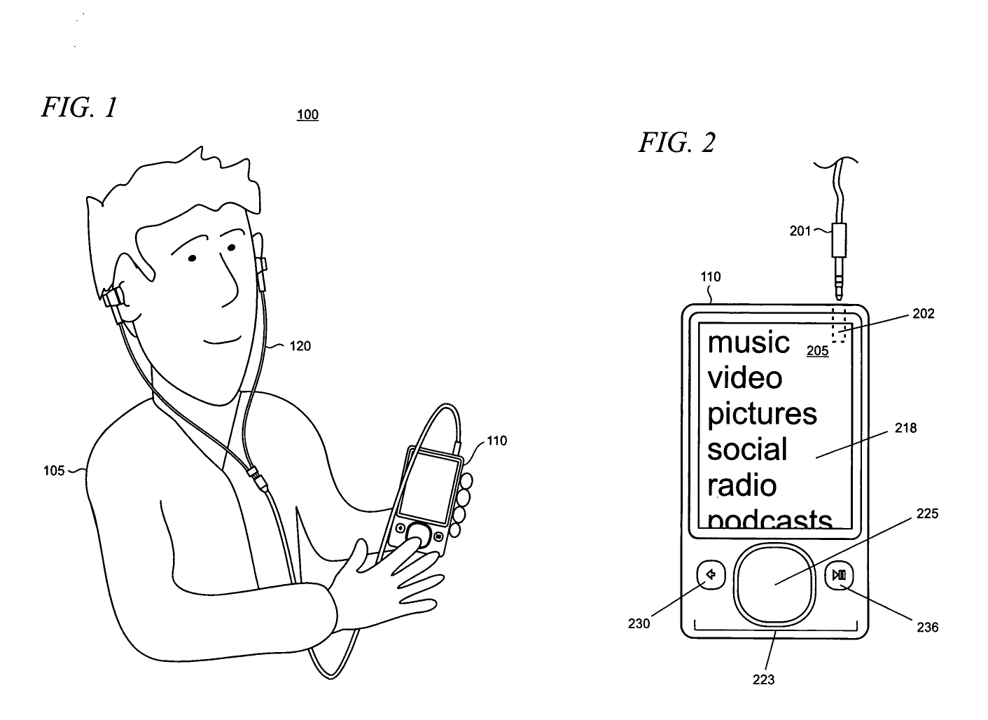

FIG. 1 shows an illustrative portable device usage environment 100 in which a user 105 interacts with digital media content rendered by a personal media player 110. In this example, the personal media player 110 is configured with capabilities to play audio content such as MP3 files or content from over-the-air radio stations, display video and photographs, and render other content. The user 105 will typically use earphones 120 to enable audio content, such as music or the audio portion of video content, to be consumed privately (i.e., without the audio content being heard by others) and at volume levels that are satisfactory for the user while maintaining good battery life in the personal media player. Earphones 120 are representative of a class of devices used to render audio content which may also be known as headphones, earbuds, headsets, and by other terms. Earphones 120 generally will be configured with a pair of audio speakers (one for each ear), or less commonly a single speaker, along with a means to place the speakers close to the user's ears. As shown in FIG. 2, the speakers are wired via cables to a plug 201. The plug 201 interfaces with an audio jack 202 in the personal media player 110.

FIG. 2 also shows a GUI 205 that is rendered on a display screen 218, and user controls 223 that are built in to the personal media player 110. The GUI 205 uses menus, icons, and the like to enable the user 105 to find, select, and control playback of media content that is available to the player 110. In addition to supporting the GUI 205, the display screen 218 is also used to render video content, typically by turning the player 110 to a landscape orientation so that the long axis of the display screen 218 is parallel to the ground.

The user controls 223, in this example, include a gesture pad 225, called a G-Pad, which combines the functionality of a conventional directional pad (i.e., a “D-pad”) with a touch sensitive surface as described in U.S. Patent Application Ser. No. 60/987,399, filed Nov. 12, 2007, entitled “User Interface with Physics Engine for Natural Gestural Control,” owned by the assignee of the present application and hereby incorporated by reference in its entirety having the same effect as if set forth in length. A “back” button 230 and a “play/pause” button 236 are also provided. However, other types of user controls may also be used depending on the requirements of a particular implementation.

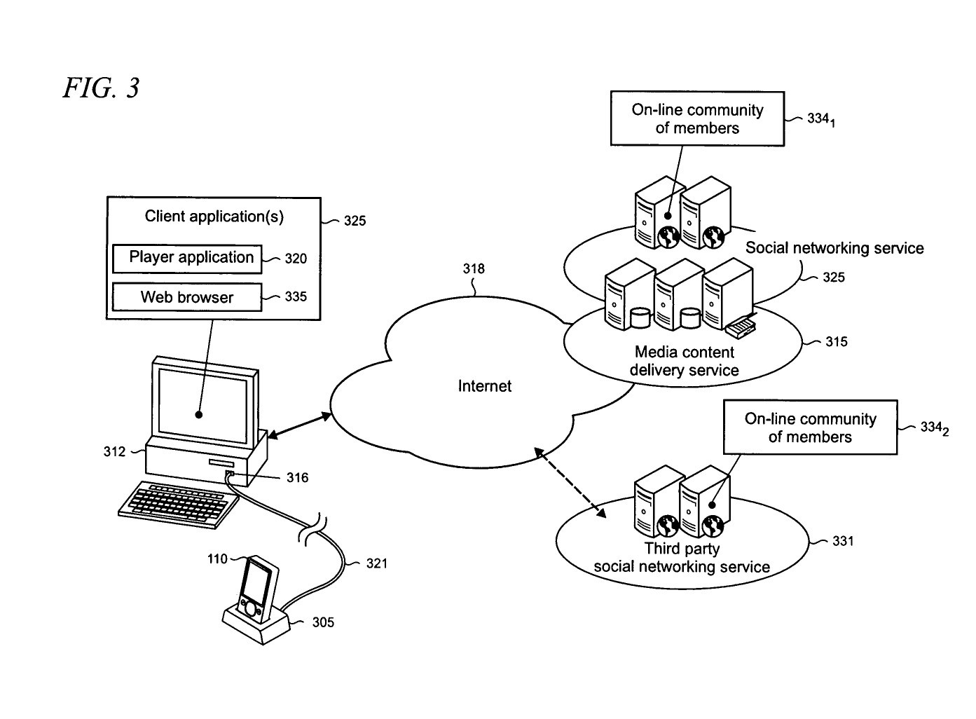

FIG. 3 shows the personal media player 110 as typically inserted into a dock 305 for synchronization with a PC 312. Dock 305 is coupled to an input port 316 such as a USB (Universal Serial Bus) port with a synchronization (“sync”) cable 321, in this example. Other arrangements may also be used to implement communications between the personal media player 110 and PC 312 including, for example, those employing wireless protocols such as Bluetooth, or Wi-Fi (i.e., the Institute of Electrical and Electronics Engineers, IEEE 802.11 standards family) that enable connection to a wireless network or access point. The wireless communications capability in the player 110 can also be utilized to implement peer-to-peer connectivity with other players that are similarly equipped.

The personal media player 110 is arranged to be operatively couplable with the PC 312 using a synchronization process by which data may be exchanged or shared between the devices. The synchronization process implemented between the PC 312 and personal media player 110 typically enables media content such as music, video, images, games, information, and other data to be downloaded from an online source or media content delivery service 315 over a network such as the Internet 318 to the PC 312. In this way, the PC 312 operates as an intermediary or proxy device between the service 315 and the personal media player 110.

The media content provided by the service 315 will typically be organized and presented to the user 105 using a player application 320 that runs on the PC 312. The player application 320 is arranged to enable the user 105 to browse, select, and download media content from the service 315, often on a fee basis or as part of a subscription plan. In some cases, advertising supported business models may also be utilized. The downloaded media content can be consumed on the PC 312 or be transferred to the personal media player 110. Media content may be protected in some instances where its limitations on its use may be enforced by various DRM (digital rights management) systems that interoperate between the PC 312 and the player 110.

In this example, a social networking service 325 supplements the media content delivery service 315. The social networking service 325 can be supported by a common service provider, as shown, but a service 331 may alternatively be provided by a third party (as indicated by the dashed line in FIG. 3). In each case, the social networking service will typically support an online community of members, as indicated by reference numerals 334₁ and 334₂.

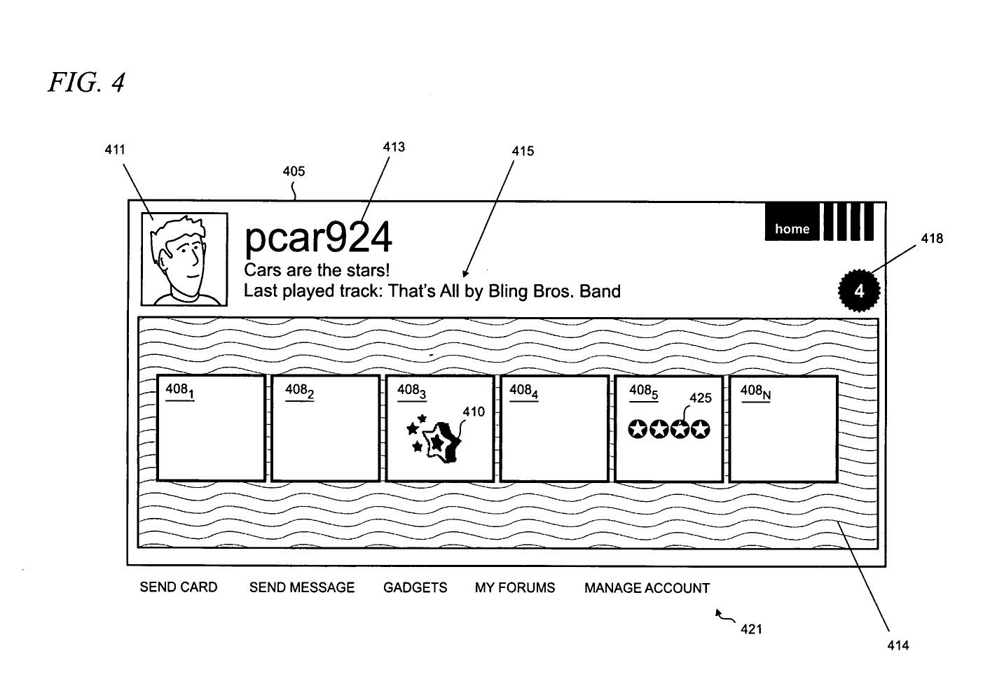

The user 105 will typically use a web browser 335 running on the PC 312 to interact with the social networking service 325. The social networking service 325 enables the online community of members 334 to explore, discover, and share media content experiences, typically including music and video. For example, a member may recommend a song to a friend, share a playlist of favorite songs, post messages/reviews/ratings in chat room and forums, and conduct discussions, and the like. The members 334 each have a profile page featuring a member card 405 that is supported by the social networking service 325, as illustratively shown in FIG. 4.

The member card 405 is automatically updated by the service 325, in this example, to reflect the music that a member plays either on their personal media player (e.g., player 110) or on the player application (e.g., player application 320) that runs on a PC. These updates are reflected by a series of tiles 408_{1, 2 . . . N} that are arranged in a moveable filmstrip-like arrangement that may be configured to scroll horizontally across the member card 405, for example. The tiles 408 will typically show a graphical representation, or thumbnail, to represent the music and may include icons, photographs, text, etc. Typically, the tiles 408 are configured as active links to the music content that they represent.

A member 334 is able to pick a picture 411 to be included in the member card 405, as well as a nickname, usemame, or “tag” or similar type of identification 413. The member card 405 can also be customized with a member-supplied background image 414, or the member 334 can pick from an assortment of service-supplied backgrounds. The member card 405 is also arranged, in this example, to show current status information such as the last song played (as indicated by reference numeral 415) and the reputation of the member as reflected by a numerical reputation badge 418. An assortment of navigation controls, collectively identified by reference 421, is also provided as shown.

In some cases, a tile 408 may be used as a badge or other token to indicate a particular status or reputation of a member 334 in the social network. For example a member 334 might receive a badge 410 for being a “power poster” (i.e., a member who posts beyond a certain number of posts on forums hosted by the service 325). The badges 410 can use different graphical symbols to denote different types of recognition.

Another type of badge is a tastemaker badge 425 which may be awarded to social network members 334 who discover new media content which then becomes popular with the rest of the network community. Eligibility for the tastemaker badge 425 is determined, in one illustrative example, by calculating a “popularity difference” for content over a time period:

popularity difference=(play count)_{current}−(play count)_{selected}

where

(play count) _{current} is the play count of content at the current calculation time and,

(play count) _{selected} is the play count of content at the time it was selected by a member for playback or for a recommendation to the community.

Thus, for example, on April 1 a member selects a song to play on the PC 312 or his media player 110 and likes the song enough to recommend it by posting messages in the social network's chat rooms or forums. At the time it was selected, the song had been played perhaps 100 times by members of the community as a whole so that (play count)_{current}=100. By May 1, a month later, the song has a play count of 1,100 so that (play count)_{current}=1100 giving a popularity difference of 1000. This means the selected song was played an additional 1,000 times by the community of members of the social network during the period of a month.

Popularity differences will generally be calculated by the reputation system per-piece of media content being played and recommended on a per-member basis. In some cases, the popularity differences will be aggregated on a per-member basis to determine eligibility for the tastemaker badge 425. For example, if a tastemaker badge requires a popularity difference of 1,000 over a one month period, then if a member 334 selected one song having a popularity difference of 600 and another with 400 in that month, then the eligibility requirements is satisfied. In other cases, eligibility for the tastemaker badge 425 will be based on single piece of media content only.

It is emphasized that popularity differences do not have to be based only on play count or recommendations. Other indicators of popularity that may be used include, for example, the frequency with which the content is designated as being a member's “favorite”, or ratings given by member to the content, or by some combination of all these criteria.

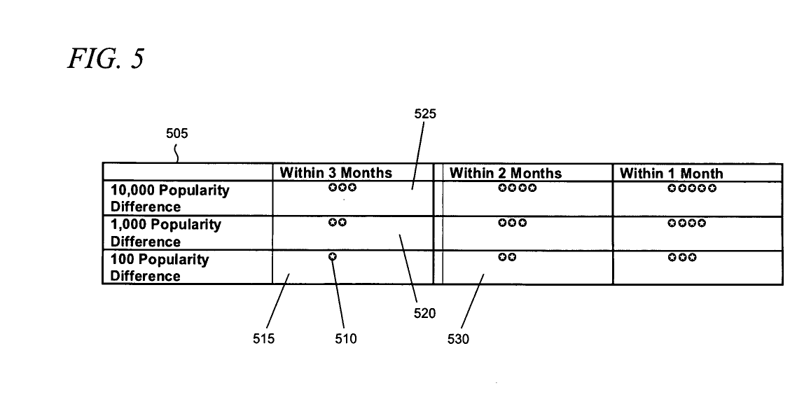

Different popularity difference thresholds may be used to award the different styles of tastemaker badges, or badges that have different attributes. In this example, as shown in FIG. 5, it is contemplated that a “star” award system will be utilized where an increased number of stars indicates a more significant or valuable award. That is a “5 Star” tastemaker badge indicates a higher level of reputation for the member 334 who holds it than a “2 Star” badge. Of course, the star award system is intended to be illustrative and any of a wide variety of alternative types of awards and/or attributes may be used as appropriate to meet the needs of a given implementation.

As shown in the table 505 in FIG. 5, award stars 510 are given based on differing threshold levels of calculated popularity differences. The thresholds in this example are chosen arbitrarily and are thus intended to be illustrative. The thresholds are arranged in the table 505 in both vertical and horizontal directions. Thus, greater levels of popularity differences in the vertical direction will result in tastemaker badges having more stars. In this case, if a member's selected content has a popularity difference of 100 within a three month period, he can get a “1 Star” tastemaker badge as indicated in entry 515 in the table 505. “2 Star” and “3 Star” tastemaker badges are likewise awarded for popularity differences of 1,000 and 10,000, respectively in a three month period, as indicated by entries 520 and 525.

In addition, to the popularity difference thresholds that are indicated in the first column of table 505, consideration may also be given to other factors. For example, the growth rate in popularity of a given piece of content may also be utilized in determining the number of stars used for the tastemaker badge. The growth rate is reflected by the entries in the third and fourth columns of the table. That is, if the popularity differences are achieved over a shorter time period, this indicates a greater rate of growth. Accordingly, a “2 Star” tastemaker badge will be awarded for a popularity difference of 100 that is achieved over a two month period of time as indicated by entry 530 in table 505. This logic is repeated for other entries so that moving up and to the right in the table gives progressively more stars. Thus, a “5 star” tastemaker badge can be received by a member 334 who picks a song, for example, that has a popularity difference of 10,000 within a time period of a single month. That means that the member 334 was able to select a song that got popular very quickly as is thus deserving of the highest award possible that confers the highest tastemaking reputation to that member.

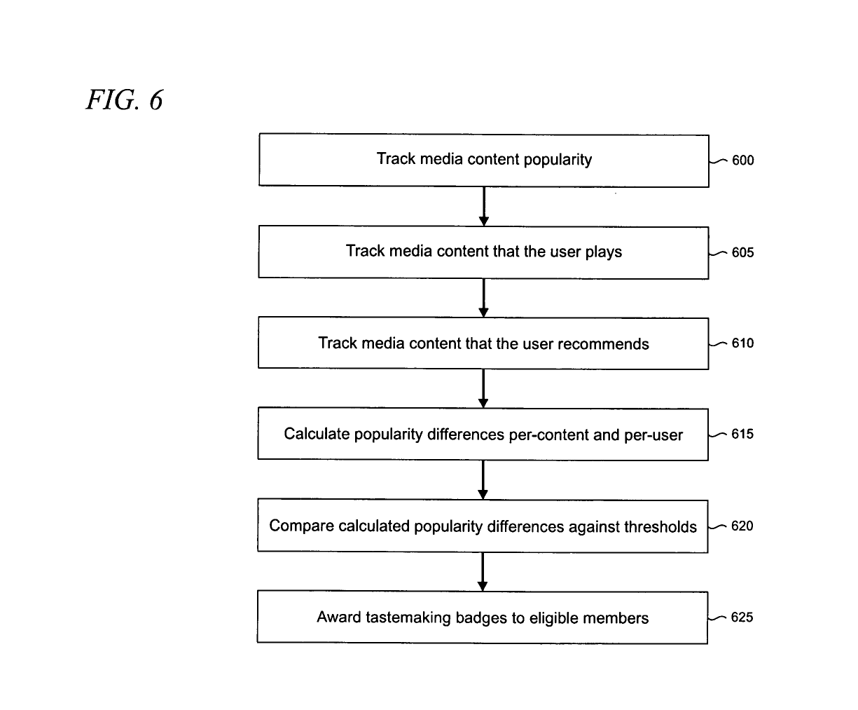

FIG. 6 is a flowchart of an illustrative method that may be used to implement the present reputation award system using a reputation system. The reputation system may be arranged as an operative element of either the media content delivery service 315 or the social networking service 325, or be distributed as functionalities across multiple services or platforms. The method here is applicable to a music example however it may be also applied to other types of media content including video, photographs, images, etc.

The reputation system is arranged to track the popularity of content including artists, albums, songs, etc., that is consumed by members of the social network on an overall basis (600). In one illustrative implementation, the popularity tracking may be performed by assigning a unique song ID (identification) to each piece of media content in the social network as well as assigning a unique ID for each member (i.e., a “source user ID”). These ID pairs can then be tracked so that as music is played from a profile page, from a message inbox when a song is sent via the messaging system, from a playlist, etc., the reputation system can properly award the correct credit to a member for the tastemaker badge as content is played in the network.

In addition, the system tracks content that is played on a per-member basis (605). The tracking can extend to both the PC 312 and player 110, for example. Content that is recommended by the member through various recommendation channels including messaging, playlists and the like, is also tracked (610). The popularity difference for each piece of content is calculated, as described above, over some time period (615) which may be a running time period (i.e., the last week, last month, etc.) or fixed period (e.g., week 1, week 2, January, February, etc.) on a per-member basis.

The calculated popularity differences are then compared against one or more thresholds, such as those shown in table 505 in FIG. 5 (620). Tastemaker badges with an appropriate number of stars can then be awarded to eligible members (625).

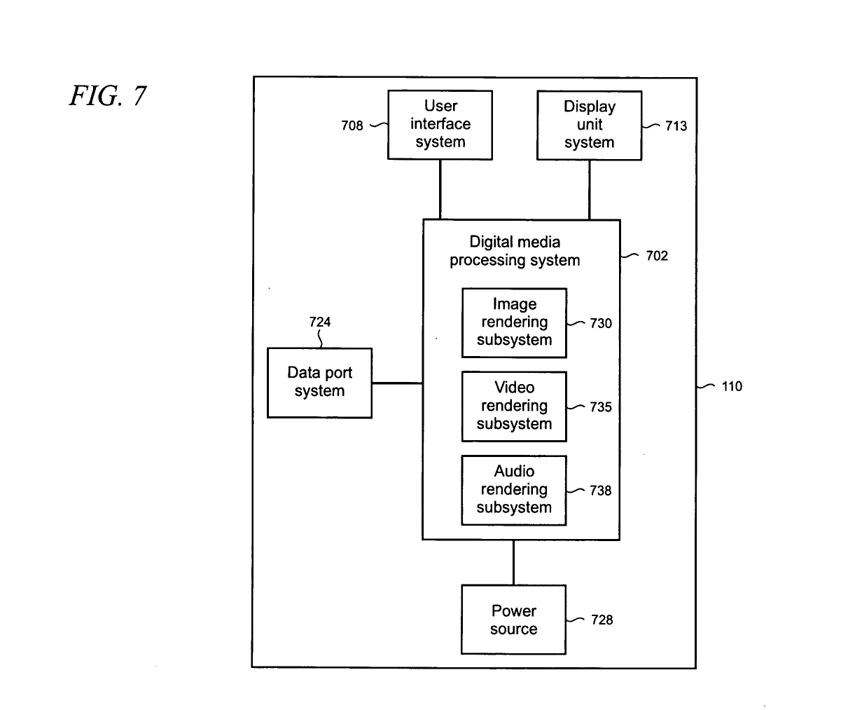

FIG. 7 is a simplified block diagram that shows various illustrative functional components of the personal media player 110. The functional components include a digital media processing system 702, a user interface system 708, a display unit system 713, a data port system 724, and a power source system 728. The digital media processing system 702 further comprises an image rendering subsystem 730, a video rendering subsystem 735, and an audio rendering subsystem 738. The digital media processing system 702 is the central processing system for the personal media player 110 and provides functionality that is similar to that provided by the processing systems found in a variety of electronic devices such as PCs, mobile phones, PDAs, handheld game devices, digital recording and playback systems, and the like.

Some of the primary functions of the digital media processing system 702 may include receiving media content files downloaded to the player 110, coordinating storage of such media content files, recalling specific media content files on demand, and rendering the media content files into audio/visual output on the display for the user 105. Additional features of the digital media processing system 702 may also include searching external resources for media content files, coordinating DRM protocols for protected media content, and interfacing directly with other recording and playback systems.

As noted above the digital media processing system 702 further comprises three subsystems: the video rendering subsystem 735 which handles all functionality related to video-based media content files, which may include files in MPEG (Moving Picture Experts Group) and other formats; the audio rendering subsystem 738 which handles all functionality related to audio-based media content including, for example, music in the commonly-utilized MP3 format and other formats; and the image rendering subsystem 730 which handles all functionality related to picture-based media content, including for example JPEG (Joint Photographic Experts Group), GIF (Graphic Interchange Format), and other formats. While each subsystem is shown as being logically separated, each may in fact share hardware and software components with each other and with the rest of the personal media player 110, as may be necessary to meet the requirements of a particular implementation.

Functionally coupled to the digital media processing system 702 is the user interface system 708 through which the user 105 may exercise control over the operation of the personal media player 110. A display unit system 713 is also functionally coupled to the digital media processing system 702 and may comprise the display screen 218 (FIG 2). Audio output through the audio jack 202 (FIG. 2) for playback of rendered media content may also be supported by display unit system 713. The display unit system 713 may also functionally support and complement the operation of the user interface system 708 by providing visual and/or audio output to the user 105 during operation of the player 110.

The data port system 724 is also functionally coupled to the digital media processing system 702 and provides a mechanism by which the personal media player 110 can interface with external systems in order to download media content. The data port system 724 may comprise, for example, a data synchronization connector port, a network connection (which may be wired or wireless), or other means of connectivity.

The personal media player 110 has a power source system 728 that provides power to the entire device. The power source system 728 in this example is coupled directly to the digital media processing system 702 and indirectly to the other systems and subsystems throughout the player. The power source system 728 may also be directly coupled to any other system or subsystem of the personal media player 110. Typically, the power source may comprise a battery, a power converter/transformer, or any other conventional type of electricity-providing power source.

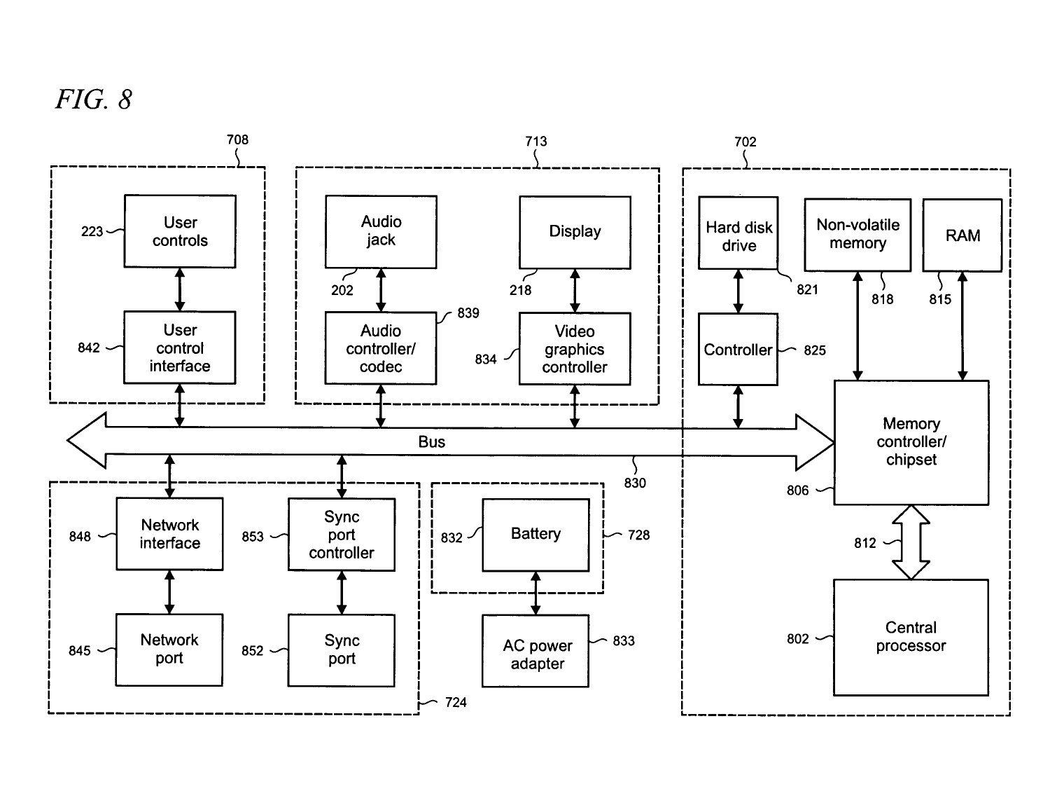

FIG. 8 is a simplified block diagram that shows various illustrative physical components of the personal media player 110 based on the functional components shown in FIG. 7 and described in the accompanying text (which are represented in FIG. 8 by dashed lines) including the digital media processing system 702, the user interface system 708, the display unit system 713, the data port system 724, and the power source system 728. While each physical component is shown as included in only a single functional component in FIG. 8, the physical components may, in fact, be shared by more than one functional component.

The physical components include a central processor 802 coupled to a memory controller/chipset 806 through, for example, a multi-pin connection 812. The memory controller/chipset 806 may be, in turn, coupled to random access memory (“RAM”) 815 and/or non-volatile memory 818 such as solid-state or Flash memory. These physical components, through connectivity with the memory controller/chipset 806, may be collectively coupled to a hard disk drive 821 (or other solid-state memory) via a controller 825, as well as to the rest of the functional component systems via a system bus 830.

In the power supply system 728, a rechargeable battery 832 may be used to provide power to the components using one or more connections (not shown). The battery 832, in turn, may also be coupled to an external AC power adapter 833 or receive power via the sync cable 321 when it is coupled to the PC 312 (FIG. 3).

The display screen 218 is associated with a video graphics controller 834. The video graphics controller will typically use a mix of software, firmware, and/or hardware, as is known in the art, to implement the GUI on the display screen 218. Along with the audio jack 202 and its associated audio controller/codec 839, these components comprise the display unit system 713 and may be directly or indirectly connected to the other physical components via the system bus 830.

The user controls 223 are associated with a user control interface 842 in the user interface system 708 that implements the user control functionality that is used to support the interaction with the GUI as described above. A network port 845 and associated network interface 848, along with the sync port 852 and its associated controller 853 may constitute the physical components of the data port system 724. These components may also directly or indirectly connect to the other components via the system bus 830.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method performed by a reputation system used with a social networking service for awarding a reputation to a member of a social network supported by the service, the method comprising the steps of:
tracking media content played by the member on a per-content basis, the media content including at least one of audio content or video content;
tracking media content recommended by the member to other members on a per-content basis; and
calculating popularity differences for played media content and for recommended media content, the popularity difference being the difference between a popularity level for media content at an arbitrary time of calculation and a popularity level at a time the media content was played by the member and at a time that the media content was recommended by the member.

2. The method of claim 1 including a further step of calculating a popularity level for all media content consumed by members of the social network.

3. The method of claim 1 including a further step of comparing the calculated popularity differences against one or more award thresholds.

4. The method of claim 3 including a further step of providing a reputation award to a member based on the results of the step of comparing.

5. The method of claim 3 in which the thresholds reflect popularity difference magnitudes or popularity difference growth rates.

6. The method of claim 4 in which the award comprises a badge that may be shown in the member's profile page supported by the social networking service.

7. The method of claim 6 in which the badge includes attributes that indicate the award's level.

8. The method of claim 7 in which the attributes include graphical elements of varying number, with an increased number of elements indicating a higher award level.

9. The method of claim 6 in which the profile page includes a member card.

10. The method of claim 9 in which the member card is personalizable by a member.
